(19) United States
(12) Patent Application Publication
(10) Pub. No.: US 2013/0276351 A1
(43) Pub. Date: Oct. 24, 2013

(54) Baiting system, device, and method of making the same

(71) Applicant: Ron Williams, Warrenton, OR (US)

(72) Inventor: Ron Williams, Warrenton, OR (US)

(21) Appl. No.: 13/862,674

(22) Filed: Apr. 15, 2013

Related U.S. Application Data
(60) Provisional application No. 61/635,659, filed on Apr. 19, 2012.

(51) Int. Cl. A01K 97/04; A01K 69/08

(52) U.S. Cl. CPC A01K 97/04; A01K 69/08
USPC 43/100; 43/58

(57) ABSTRACT

The present invention includes a system for improving the speed and ease of attaching, removing, and cleaning bait-cans when used for crabbing. A punch machine pierces one or more holes in a bait-can that resembles a large tuna can. This can, in turn, inserts into a new hanger device that is generally C-shaped with the open notch at the bottom and a pair of retainers at the top. The can is simply snapped into the hanger. The hanger attaches to a crab pot but suspends the bait can off the floor of the pot. In another version, the hanger includes two opposed arms that can be used to stabilize an existing bait device in the known art.

### PRIORITY CLAIM

The present application claims benefit pursuant to 35 U.S.C. §119(e) and 37 CFR1.78(a)(4)-(a)(6) to co-pending U.S. Provisional Patent Application No. 61/635,659 filed on Apr. 1, 2012.

### BACKGROUND

The present invention relates to bait containers and associated bait container hangers for crab pots and the like. More specifically, the present invention relates to a system of rapidly inserting a bait can on a dedicated hanger that attaches to a conventional crab pot and the like.

Both the sport and the commercial fishing industry employ crab pots of various designs and material to capture live crabs from the floor of the ocean, bay, or inlet, for example. Typically, a rope (or line or cord) extends from the crab pot to a marker buoy. The marker buoy may bob on the surface of the water, or may be submersed and include a release mechanism that will release the buoy to the surface under particular conditions, such as a timed release or a radio-frequency release operated by a fisherman.

Crab pots rest on the ocean floor, enticing live crabs inside using bait. The bait is typically inserted into a device that has an interior volume defined by exterior walls having a plurality of holes so that the scent of the bait escapes, but the bait remains in the device so that it serves to entice many crabs over time.

Once one or several crabs enter the pot, they are unable to escape. Fishermen leave unattended several crab pots on the ocean floor. Periodically, the fishing vessel returns to the buoy attached to the corresponding crab pot and a fisherman connects the line extending from the pot to a pulling device, such as a hand winch or motorized winch, via a pulley block mounted on the vessel; thus affecting retrieval of the pot from the ocean floor. At this time the bait can needs to be de-coupled from the crab pot and the bait removed from the bait device.

Currently, there is no system that allows for rapid deployment and removal of a bait device from a crab pot. For deployment of fresh-bait, the current art teaches a two-part bait device: A worker (crabber) fills the body with fresh bait, and a screw cap then covers the body securing the bait in the device. Then, a long, skinny, difficult-to-manipulate hook is attached—one end to the bait device and the other end to the crab pot. Next a rubber-band or other mechanical fastener secures the hook relative to the crab pot to prevent unwanted dislodging of the bait device when the pot is tossed into the ocean. Upon removal, this process is reversed when the crab-pot is hauled aboard, with the additional step of rinsing the opened bait device to clean the putrid bait from the device.

There are many problems with this current method and device including that the existing bait devices are very difficult to clean. They are expensive to manufacture and very time consuming to deploy. These difficulties are multiplied on a commercial vessel where time is a crucial factor to a successful and safe harvest.

Of particular concern, the existing art is dangerous to the crabbers as the current practice teaches filling the existing bait-device on board a moving ocean-going crabbing vessel and the bait is chopped up using knives, hatchets, and the like. Moreover, the deck often becomes slippery with the fish-guts and other fluids from preparing the bait—in some instances people have fallen overboard and drowned from slipping on the fish-oil covered decks. Further, the existing method is time-consuming and takes away from productive time catching crab. And, the existing bait-devices have been known to open when the pot is tossed in the water, and the pot is useless to catch crabs and has to be reset. Thus, there is a need for a system, method, and device that overcomes the limitations of the current art.

### DRAWING

FIG. 1 is a front view of one preferred embodiment of a bait-can hanger of the present invention.

FIG. 2 is a side view of the bait-can hanger of FIG. 1.

FIG. 3 is a front view of a bait can according to one preferred embodiment of the present invention.

FIG. 4 is a front view of one preferred system of the present invention and includes the bait-can hanger of FIG. 1 and the bait-can of FIG. 3.

FIG. 5 is an offset frontal view of the system of FIG. 4.

FIG. 6 is front view of a PRIOR-ART bait-device.

FIG. 7 is a side view of a second preferred embodiment of a bait-can hanger of the present invention.

FIG. 8 is a front view of the bait-can hanger of FIG. 7.

FIG. 9 is an offset frontal view of a system of FIG. 4 in one possible environment of use.

FIG. 10 is a front view of a PRIOR-ART clip used to hold a prior-art bait device.

FIG. 11 is an offset frontal view of a PRIOR-ART method for connecting a PRIOR-ART bait device.

FIG. 12 is an offset frontal view of a bait-can punching machine according to one preferred embodiment of the present invention.

FIG. 13 is a frontal view of a system according to yet another embodiment of the present invention and includes the bait-can punching machine of FIG. 12 in a possible environment of use.

FIG. 14 is an offset frontal view of a third preferred embodiment of a bait-can hanger according to the present invention.

### DESCRIPTION OF THE INVENTION

Possible embodiments will now be described with reference to the drawings and those skilled in the art will understand that alternative configurations and combinations of components may be substituted without subtracting from the invention. Also, in some figures certain components are omitted to more clearly illustrate the invention.

The present invention contemplates a system for creating bait cans and a system for attaching the bait cans to existing crab pots, for example. And, the various preferred embodiments of the present invention—including devices, systems, and methods—eliminate many of the shortcomings taught in the prior art. Particularly, the present invention eliminates from moving vessels the practice of chopping bait. This eliminates the use of dangerous knives and hatchets on a pitching deck; this eliminates a slippery deck caused by the bait-chopping operation, and—accordingly—greatly reduces the chance of a deck hand falling overboard. Further, the existing method is much more time-efficient allowing crabbers to have higher productivity when on-board the vessel.

One particular advantage of the present invention includes the bait-can hanger 12, described below, that enables a bait can 30, described below, to attach to a conventional crab-pot. However, unlike the teaching of the prior art, the present invention enables the bait can to stand proud from the ocean bottom and swivel in about 360-degrees of arc travel in a plane parallel to, but offset from, the ocean bottom. Another advantage, the system 10 provides superior bait and a deployment system that is far quicker to deploy initially, quicker to remove spent-bait from the trap, and quicker to clean bait from the bait can, than those systems of the prior art. In fact, another advantage of the present system 10 is the cleaning of the bait trap is no longer required as taught in the prior art: Instead, the bait can 30 is simply discarded and a new bait-can is put in its place. Part of this convenience includes an economically less expensive bait-can than taught in the prior art. For example, the can 30 can be adapted from existing canning technology, particularly the canning of fish parts normally discarded in the fish-cannery processes. And, the can 30 can be similar to a conventional “tuna” can in size, shape, and other dimensions, including material. Additional steps are needed to turn a conventional can into a suitable bait can 30, as described below.

Further, existing crab pots can be used with the various embodiments of the present invention. However, the present invention is much faster to deploy on a boat, requires no set-up time, eliminates cleaning of used bait traps of the prior art, and requires virtually no time to remove from the trap. This will revolutionize the efficiency of trapping crabs for the commercial crabbing industry.

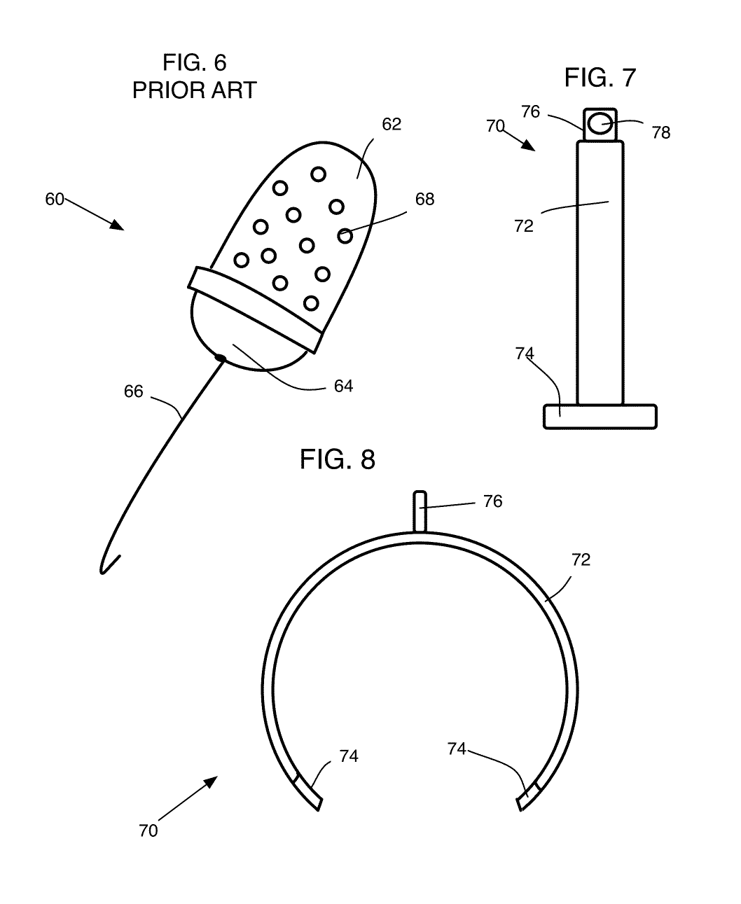

FIGS. 6, 10, and 11 illustrate one prior-art bait-can device 60 having a body 62 and screw top lid 64. The top lid and body define a chamber and several holes 68 extend through the surface of the body to enable the scent of any bait inserted in the chamber to permeate. The bait device includes a hook 66 for attaching to the crab pot. The hook attaches to a rope R having a collar C, which is looped through the retainer 66. Some systems of the prior art use a pin P (FIG. 10) to couple the device 60 to the bottom of the trap.

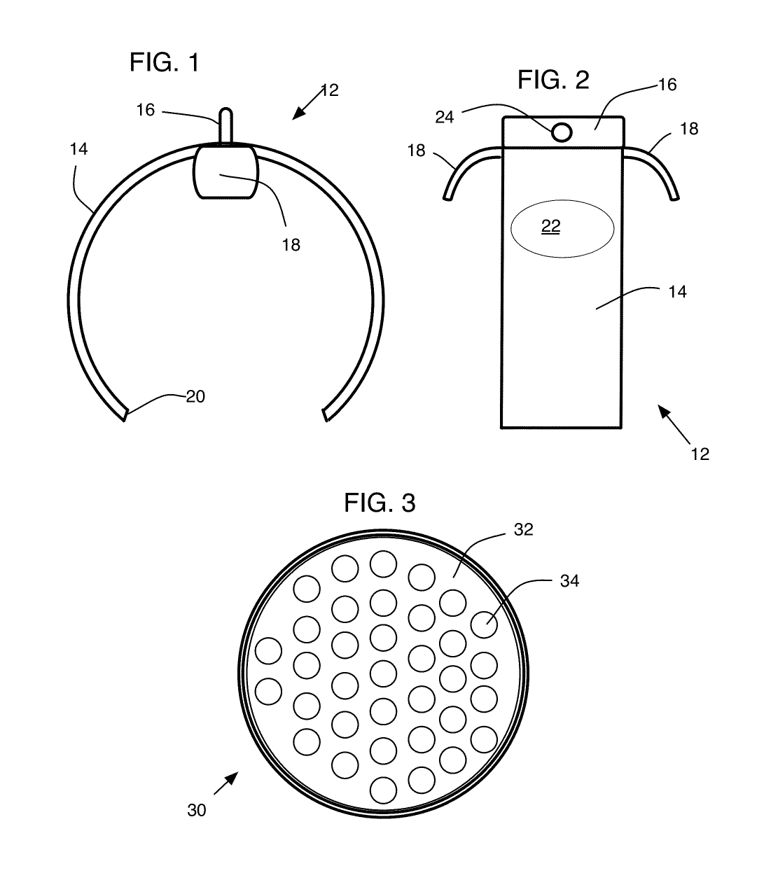

FIGS. 1 and 2 illustrate one preferred embodiment of a bait-can hanger 12 of the present invention. The bait-can hanger 12 includes a curvilinear body member 14 that appears generally c-shaped in profile and is more specifically a circular or elliptical body member having a depth. The body member has two opposed ends 20 that form a notch or opening. This opening facilitates insertion of a bait-can 30, described below. The body 14 includes at least two (arranged as a pair) retaining members 18, one on the front face starting at the top and extending horizontally away from the body then curving downward. The second retaining member, identical to the first, positions on the rear face of the body 14. The body also includes a vertical fin 16 extending the depth of the body positioned on the top portion. The vertical fin 16 provides an eyelet 24 for coupling the bait-can hanger 12 to an external object such as a crab pot or buoy or fishing line, for example. The body 14 includes a surface 22 well suited for labeling or marking the brand of the hanger 12.

A bait-can 30, as FIG. 3 illustrates, of the present invention consists of a tuna-can-like tin, steel, or aluminum can having a general shape of a flat hockey puck, circular when viewed from the front. The can includes a can body having a first front face 32 having at least one hole 34, and more ideally a plurality of holes 34 arranged on both the front face and rear face of the can body.

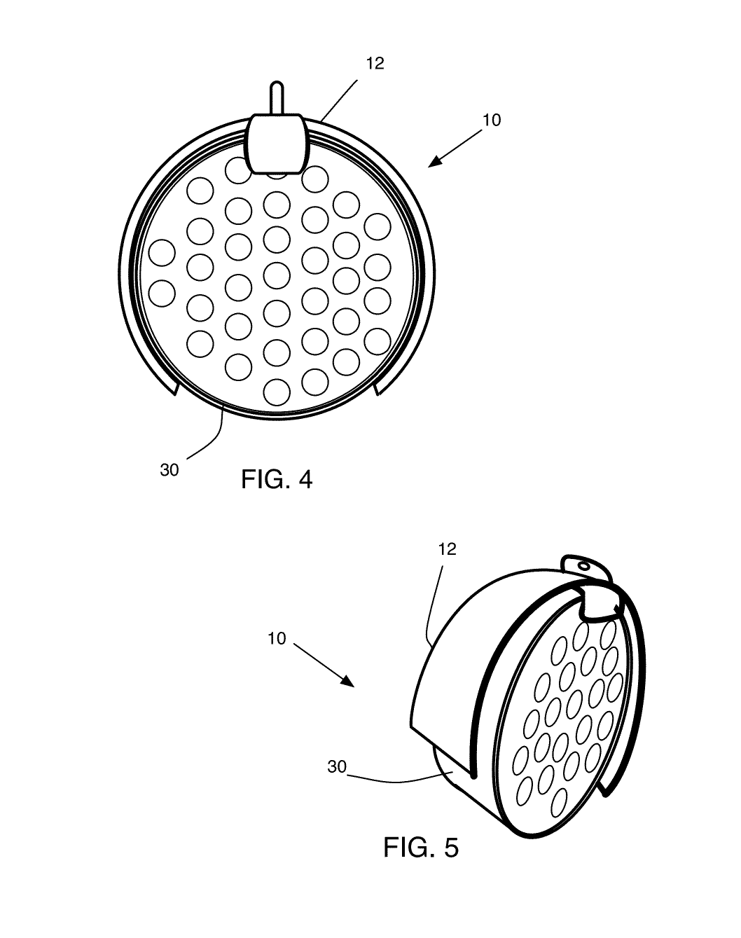

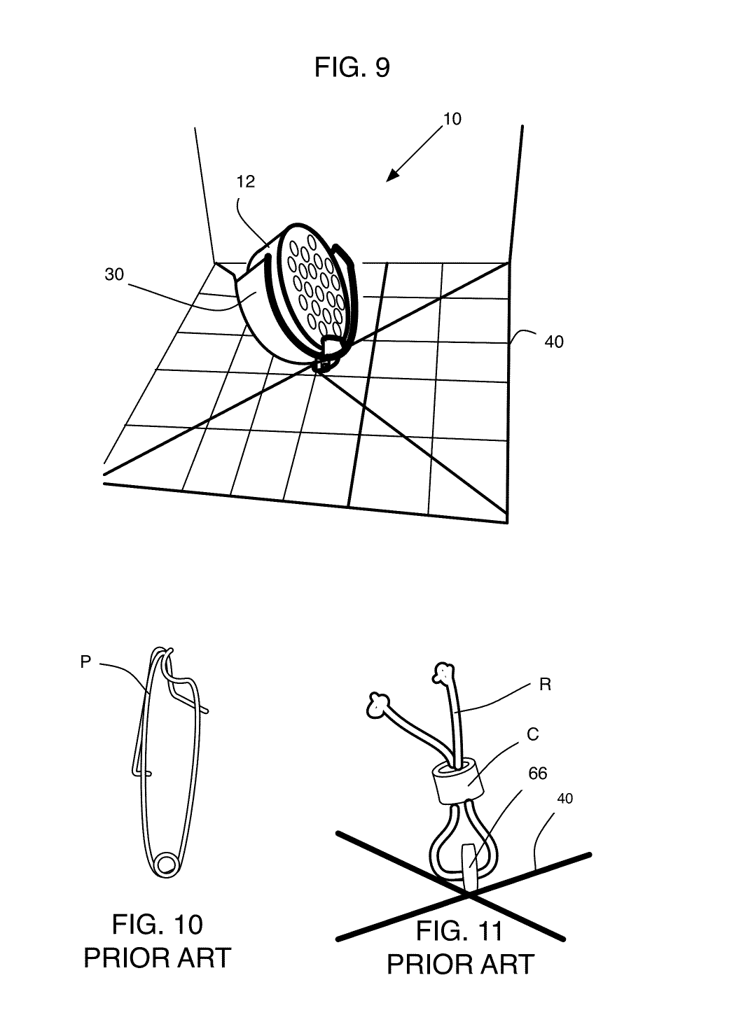

FIGS. 4 and 5 illustrate a first preferred system 10 of the present invention, which includes the previously mentioned bait-can hanger 12 of FIGS. 1 and 2, and the bait-can 30 of FIG. 30, for example. And, as FIG. 9 shows, the system 10 attaches to the bottom of a crab pot 40, but is suspended from the floor of the pot (and of the ocean) because the rigid connection provided by the hanger 12 to the can 30 in relation to the crab pot 40. To ensure swiveling of the bait an 30, the hanger 12 couples to the pot, as would be appreciated by those with ordinary skill in this art, using industry accepted stainless steel wire, plastic zip ties, and the like, for example.

A second preferred embodiment of the present invention contemplates a bait-device hanger 70 adapted to selectively and releasably couple to a prior-art bait device, such as the known bait-device 60 of FIG. 6. Such prior art bait-devices 60 include a body 62 fabricated from stainless steel or aluminum, or molded from plastic. The body includes a threaded lid 64 and the lid and body form an enclosed chamber. Several holes 68 are drilled into the body. And a long, skinny hook-like device 68 attaches to the device 60. The hook couples to a crab pot. The bait device 60 then sits on the bottom of the pot at the bottom of the crate. Often the hook is further secured with a rubber band or other clamping device. The bait-device hanger 70, as FIGS. 7 and 8 show, adapts to clip to this prior art device. As such the prior-art hook is no longer needed with the hanger 70 of the present invention. Further, the rigid support that the hanger provides, along with the ability of the hanger 70 to swivel about 360-degrees arc in a plane parallel to, but offset from, the ocean bottom enables the prior-art device to be suspended from the floor improving the bait-scent and reducing the amount of sand that enters the bait-device.

As FIGS. 7 and 8 show, the bait-device hanger 70 has a circular body 72 (when viewed from the front as FIG. 8 shows). The circular body has a notched opening at the bottom to enable the prior-art bait device 60 to simply snap in place, thus securing the device 60 in the hanger 70 without needing any tools. Further the bait device can be quickly removed by hand, yet it is held firmly in place when deployed in a trap. The body 72 is made of a flexible material such as plastic or stainless steel and acts as a biasing member. A pair of oppositely positioned arms 74 locate at the bottom of the body member 72 and define the bottom notch. The arms 74 help stabilize the body 62 of the bait-device 60. At the top of the hanger body 72, a vertical rib 76 extends and supports an eyelet 78. A zip-lock device can than secure the hanger 70 to a crab-pot as would be conventionally understood. Better, a mechanical swivel mount can be used to couple the hanger 70 to the crab-pot.

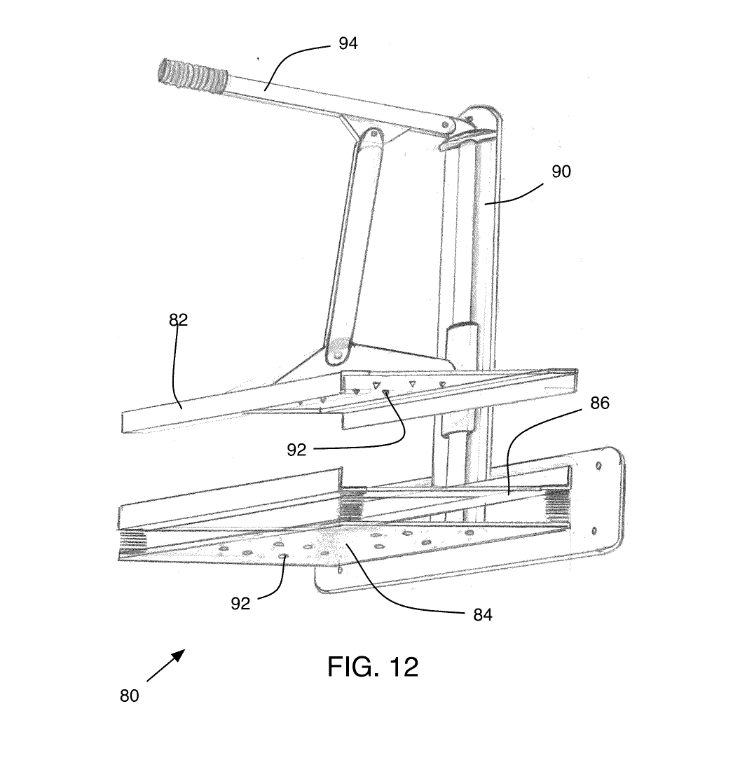

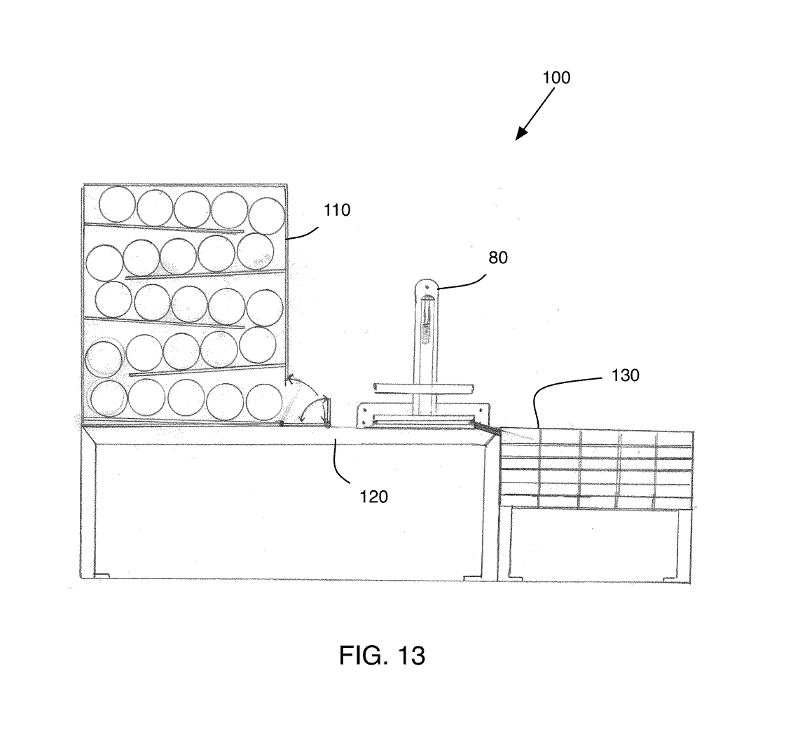

FIGS. 12 and 13 illustrate a punching machine 80 adapted to pierce the bait-can 30 of the present invention. As such, the machine 80 includes a support structure for supporting the various components. A lever 94 operates between an open position and a closed position and such movement causes a top perforating plate 82 to travel in a vertical line. A can 30 is placed between the top plate 82 and on top of a frame 86. The frame is supported above and parallel to a bottom perforating plate 84 by one or more biasing (springs) members 88. Thus, as the lever is pulled downward, the top plate moves against the can, the top plate and can push on the frame, overcoming the biasing means and the bottom of the can contacts one or more piercing teeth 92 and the continued downward force on the lever causes the top plate having one or more piercing teeth to puncture the top of the can while the bottom plate teeth puncture the bottom of the can.

FIG. 13 illustrates the punching machine 80 of FIG. 12 in relation to a workstation, which could be on a boat in the ocean, for example. The workstation 100 includes a dispensing rack 110 for holding cans 30 waiting to be punctured, a work surface 120 and a ready-rack 130.

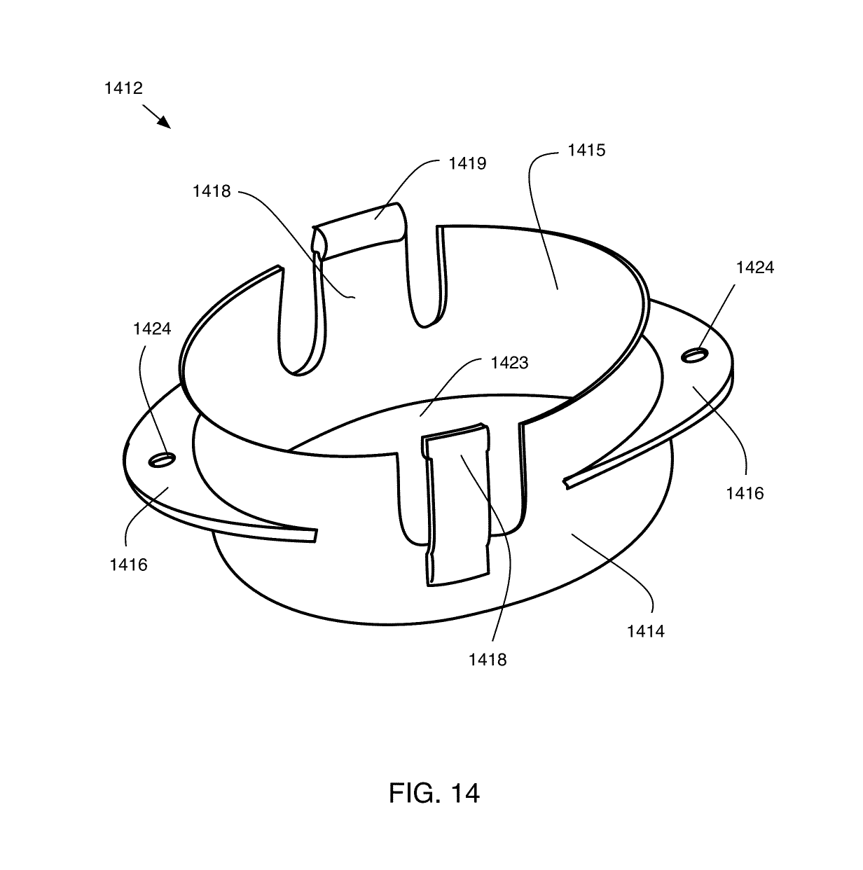

FIG. 14 illustrates yet another preferred embodiment of a bait-can hanger 1412 of the present invention. The bait-can hanger 1412 includes a curvilinear body member 1414 that appears generally as a closed oval or closed circle when viewed from the top. This circular or elliptical body member has a depth and a closed end 1423 for preventing a bait can from sliding all the way through the body member 1414. The body member has at least two opposed retainer ends 1418 that include a corresponding notch in a sidewall of the body to enable the retainer end 1418 to deflect away from the center of the body when a can is inserted, and then spring back to retain the can by means of the retention arms 1419. This opening facilitates insertion of a bait-can 30, described below. The body 1414 also includes at least one horizontal fin 1416 having a corresponding eyelet 1424 for coupling the bait-can hanger 1412 to an external object such as a crab pot or buoy or fishing line, for example. The body 1414 includes a surface well suited for labeling or marking.

Although the invention has been particularly shown and described with reference to certain embodiments, it will be understood by those skilled in the art that various changes in form and detail may be made without departing from the spirit and scope of the invention. And, although claims are not required, I claim at least:

I claim:

1. A system of baiting a crab pot, the system comprising:
a hanger adapted to couple to the crab pot, the hanger comprising a curvilinear body member having at least one pair of cooperating retaining members, and the body further having at least one fin having a corresponding eyelet; and
a bait can adapted to insert in the hanger and selectively release from the hanger.

2. The system of claim 1 wherein:
the hanger further comprises a curvilinear body member comprising at least one sidewall disposed to define a closed oval or circle, the body member further having a closed bottom and open top;
the at least one fin comprises a horizontal fin; and
the body member further comprise at least one pair of cooperating retaining members arranged at opposite sides adjacent to a top edge of the at least one sidewall.

3. The system of claim 1 wherein:
the hanger further comprises a curvilinear body member comprising a C-shaped body having a pair of oppositely disposed retainers at a top portion of the body and wherein the at least one fin comprises a vertical fin disposed at a top portion of the body wherein the C-shaped body has an opening arranged at a bottom end of the body.

4. The system of claim 1 wherein:
the bait-can comprises a disc-shaped device having a depth and a front face and a rear face, the front face includes at least on hole thereon and a rear face with at least one hole thereon.

5. The system of claim 1 further comprising:
a hole-punching device adapted to simultaneously pierce at least one hole on the bait-can front face and at least one hole on the rear face.

6. The system of claim 1 wherein:
the curvilinear body further comprises a C-shaped body member arranged so an opening is disposed at the bottom of the body member and the at least one fin comprises a vertical fin disposed on the top of the body member, and wherein the C-shaped body member further comprises a pair of oppositely disposed retaining arms located at the bottom of the body.

7. A hanger device for holding a can of bait, the device comprising:
a curvilinear body member having at least one pair of cooperating retaining members, and the body further having at least one fin having a corresponding eyelet.

8. The hanger device of claim 7 further comprising:
the hanger further comprises a curvilinear body member comprising at least one sidewall disposed to define a closed oval or circle, the body member further having a closed bottom and open top;
the at least one fin comprises a horizontal fin; and
the body member further comprise at least one pair of cooperating retaining members arranged at opposite sides adjacent to a top edge of the at least one sidewall.

9. The hanger device of claim 7 further comprising:
the hanger further comprises a curvilinear body member comprising a C-shaped body having a pair of oppositely disposed retainers at a top portion of the body and wherein the at least one fin comprises a vertical fin disposed at a top portion of the body wherein the C-shaped body has an opening arranged at a bottom end of the body.

10. The hanger device of claim 7 further comprising:
the curvilinear body further comprises a C-shaped body member arranged so an opening is disposed at the bottom of the body member and the at least one fin comprises a vertical fin disposed on the top of the body member, and wherein the C-shaped body member further comprises a pair of oppositely disposed retaining arms located at the bottom of the body.
